(19) United States
(12) Patent Application Publication
(10) Pub. No.: US 2023/0075491 A1
(43) Pub. Date: Mar. 9, 2023

(54) Roof Module for Forming a Vehicle Roof Having a Displaceable Cleaning Nozzle

(71) Applicant: Webasto SE, Stockdorf (DE)

(72) Inventors: Cedric LANGLAIS, Stockdorf (DE); Magnus SVIBERG, Stockdorf (DE); Nikolaus LINNER, Stockdorf (DE)

(21) Appl. No.: 17/893,687

(22) Filed: Aug. 23, 2022

(30) Foreign Application Priority Data
Sep. 3, 2021 (DE) 10 2021 122 877.8

(51) Int. Cl. G01S 7/497; B60S 1/56; B60R 11/04; G01S 17/931

(52) U.S. Cl. CPC G01S 7/497; B60S 1/56; B60R 11/04; G01S 17/931; B60R 2011/0045

(57) ABSTRACT

A roof module for forming a vehicle roof having a panel component whose external surface at least partially forms a roof skin of the vehicle roof, the roof skin functioning as an outer sealing surface of the roof module, the roof module having at least one module component, the roof module having a drive kinematic unit which is configured to displace the at least one module component from a retracted position to an extended position in which the at least one module component protrudes over the roof skin, and the roof module having at least one cleaning nozzle. The drive kinematic unit may be configured to also displace the at least one cleaning nozzle between a retracted position and an extended position.

### CROSS-REFERENCE TO RELATED APPLICATION

This application claims priority from German patent application no. 10 2021 122 877.8 filed on Sep. 3, 2021, which is hereby incorporated herein by reference in its entirety for all purposes.

### FIELD

The invention relates to a roof module for forming a vehicle roof on a motor vehicle according to the preamble of claim 1.

### BACKGROUND

Generic roof modules are commonly used in the field of vehicle construction as these roof modules can be prefabricated as separate function modules and delivered to the assembly line for the vehicle assembly. On its exterior surface, the roof module at least partially forms a roof skin of the vehicle roof which prevents moisture or air flow from permeating the vehicle interior. The roof skin is formed by one or several panel components which can be made of a stable material, for example painted sheet metal or painted or thoroughly died plastic. The roof module can be part of a fixed vehicle roof or part of an openable roof module.

Furthermore, vehicle construction development increasingly focuses on autonomously or semi-autonomously driven motor vehicles. To enable the vehicle control system to control the motor vehicle autonomously or semi-autonomously, a plurality of environment sensors (for example lidar sensors, radar sensors, (multi) camera sensors etc. including further (electrical) components) are used which are, for example, integrated in the roof module, detect the environment around the motor vehicle and, for example, determine a respective traffic situation from the detected environment data. Roof modules provided with a plurality of environment sensors are also known as roof sensor modules (RSM). The known environment sensors send and/or receive corresponding electromagnetic signals, for example laser beams or radar beams, a data model being generated by means of a corresponding signal evaluation and used for controlling the vehicle.

Most commonly, the environment sensors for monitoring and detecting the vehicle environment are attached to the vehicle roof, as the vehicle roof is usually the highest point of a vehicle from which the vehicle environment is highly visible. Most commonly, the environment sensors are formed as an attachment and are fitted on the panel component of the roof module forming the roof skin, but they can alternatively also be disposed in an opening of the roof module so as to be displaceable between a retracted position and an extended position.

During the operation of the vehicle, sections of the roof module, for example a ((partially) transparent) see-through portion, through which the environment sensor detects the vehicle environment, are at risk of being contaminated or become non-transparent for the environment sensor because of environmental influences (for example weather conditions). Using cleaning nozzles by means of which the see-through portion can be cleaned is known for cleaning these sections. Similar to spraying nozzles of a windscreen wiper system, known cleaning nozzles are commonly statically disposed in an area of the roof module or the panel component which, viewed in the direction of an optical axis of the environment sensor, is disposed in front of the environment sensor. However, as this is contrary to aesthetic aspects and as cleaning nozzles disposed in this manner can also create shadowed areas in the field of view of the environment sensor, it is also known to design cleaning nozzles so as to be retractable and extendable.

In the state of the art, these cleaning nozzles are extended by means of a hydraulic drive, i.e., by means of a water pressure of the cleaning nozzle itself. A retracting of the cleaning nozzle is commonly caused by a restoring spring, against whose restoring force the hydraulic drive also operates when extending the cleaning nozzle, such that a high hydraulic pressure must be provided for extending the cleaning nozzles. In addition, these known cleaning nozzles also have other disadvantages, as each cleaning nozzle requires its own hydraulic drive or its own valve control, for example. Each of these components requires additional assembly space, which is particularly disadvantageous in areas where space is limited, for example in the roof area. Furthermore, the hydraulic systems can only be moved along a predetermined direction, namely along a hydraulic path of the cleaning nozzle, which limits both construction flexibility and design options when positioning the cleaning nozzles. Initiating the movement can also be delayed because of a latency period which is defined by a period of time required for a pressure build-up within the hydraulic drive system and which can amount to several seconds. Thus, at least the extending movement cannot be precisely controlled. Another problem is that because the cleaning nozzles are retracted and extended hydraulically, no service position in which maintenance could be carried out on the cleaning nozzle can be reached. Additionally, because of the hydraulic drive, there is no guarantee for the cleaning function to work in cold outside temperatures or when a cleaning nozzle is contaminated, because both frozen and contaminated nozzles may prevent the hydraulic pressure necessary for the extending movement from building up.

### SUMMARY

Thus, an object of the invention is to provide a roof module which prevents the disadvantages of the state of the art mentioned above.

This object is attained by a roof module according to the teachings of claim 1.

Advantageous embodiments of the invention are the subject matter of the dependent claims.

The roof module according to the invention for forming a vehicle roof on a motor vehicle comprises a panel component whose external surface at least partially forms a roof skin of the vehicle roof, the roof skin functioning as an outer sealing surface of the roof module. The roof module further comprises at least one module component and a drive kinematic unit. The drive kinematic unit is configured to displace the at least one module component from a retracted position to an extended position in which the at least one module component protrudes over the roof skin. Furthermore, the roof module comprises at least one cleaning nozzle. The roof module according to the invention is characterized in that the drive kinematic unit is configured to also displace the at least one cleaning nozzle between a retracted position and an extended position.

The roof module according to the invention has the advantage that because the at least one cleaning nozzle is moveable between the retracted position and the extended position, no cleaning nozzles are disposed in a viewing area of an environment sensor. Thus, the at least one cleaning nozzle does not create a blind area in which the environment sensor is unable to adequately detect the vehicle environment because of shading caused by the cleaning nozzles. Instead, the environment sensor can unimpededly detect the vehicle environment in its entire detection range. This increases the safety and detection accuracy of the environment sensors.

Opposite to the state of the art, the roof module according to the invention is also designed without a hydraulic adjustment drive for displacing the cleaning nozzle(s), such that the disadvantages associated with the hydraulic adjustment technology do not occur according to this invention. Instead, the drive kinematic unit according to the invention allows the module component and the cleaning nozzle to be retracted and extended (electro-)mechanically. In this case, the retractability and extendability of the cleaning nozzle is no longer coupled to a hydraulic pressure, such that the pressure level of the at least one cleaning nozzle (or of the cleaning circuit) can be lowered compared to a hydraulic drive commonly used in the state of the art. Additionally, (pilot) control valves are not required, thus also reducing assembly space. The decreased system pressure also allows the use of smaller pumps (with a lower pressure level), thus further reducing assembly space and energy. By using the preferably electromechanically drive kinematic unit, a retracting and/or extending of the at least one cleaning nozzle is possible within a shorter latency period compared to a hydraulic drive, since in the case of an electromechanical drive, there is no longer a delay because of a pressure build-up. Instead, the adjustment energy can be provided directly (i.e., within a few milliseconds). Additionally, the drive kinematic unit according to the invention is decoupled, i.e., independent of a fluid circuit of a cleaning fluid, such that the at least one cleaning nozzle can be displaced to a maintenance position, for example. This also ensures that the at least one cleaning nozzle can be moved during a cleaning process, for example, which has not been possible with hydraulic drives. This has not been possible with known prior art.

In particular, the roof module according to the invention is advantageous in that one and the same (i.e., one single) drive kinematic is used to both displace the at least one module component and the at least one cleaning nozzle. Thus, not several drive kinematic units are used, but instead the functionality of one single drive kinematic unit is enhanced such that both the at least one module component and also the cleaning nozzles are displaceable, preferably independently from each other. Thus, the drive kinematic unit can be used in a synergistic manner. This means that no separate drive kinematic unit must be provided for displacing the at least one cleaning nozzle. Thus, it is furthermore possible to reduce assembly space. This also reduces the complexity of the assembly and maintenance of the roof module. Additionally, the amount of required components is reduced, thus enhancing the efficiency of the assembly and maintenance. Because of the reduced number of parts and also because of the reduced required assembly space, the use of one single drive kinematic unit according to the invention allows a high level of design freedom for the construction and layout of the roof module. By means of the mechanical displaceability of the at least one cleaning nozzle using the same drive kinematic unit by means of which the at least one module component is also displaceable, the cleaning nozzle is also no longer prone to a function failure because of dirt or coldness, as the mechanical drive kinematic unit can be designed much more robust.

To provide the properties according to the invention, the design of the drive kinematic unit is changed such that it allows both a displacing of the at least one cleaning nozzle and a displacing of the module component, preferably in separate movement sequences. In this case, the at least one cleaning nozzle is preferably not disposed on the module component itself. Thus, the at least one cleaning nozzle is preferably disposed at a distance from the at least one module component and thus they do not share a housing, for example.

“At least one module component” means that the roof module can comprise one or several module components. “At least one cleaning nozzle” means that the roof module can comprise one or several cleaning nozzles. It is obvious that the environment sensor can also be part of a sensor module which is comprised in the roof module and which can comprise the environment sensor and additional electrical components and/or mechanical components (e.g., a housing, parts of a housing and/or a drive, etc.).

Preferably, the roof module comprises at least two cleaning nozzles which are displaceably disposed at a distance from each other in a shared opening or in two separate openings in the panel component of the roof module. In this case, the at least two cleaning nozzles are preferably disposed so as to be separate or distanced from the module component. Furthermore, the roof module can have one or several hose lines and/or a tank for cleaning fluid for cleaning purposes. Alternatively, it is also possible to use an existing tank for cleaning fluid used to clean the front and rear windows as a reservoir for the cleaning fluid. The extended position does not necessarily mean a fully extended position. Thus, it is possible, for example, that the at least one cleaning nozzle is only moved to a not fully extended position, provided that only a section of a see-through portion (e.g., because of contamination in certain areas) requires cleaning, for example.

The roof module according to the invention can form a modular unit in which devices for autonomously or semi-autonomously driving assisted by driving assistance systems are integrated and which can be fitted on a vehicle shell structure as a unit by a vehicle manufacturer. Furthermore, the roof module according to the invention can be formed as an entirely fixed roof or as a roof including a roof opening system. Additionally, the roof module can be designed for passenger cars or commercial vehicles. The roof module can preferably be provided as a modular unit in the form of a roof sensor module (RSM) in which the environment sensors are provided, so as to be inserted in a roof frame of a vehicle shell structure as a suppliable modular unit.

In general, the environment sensor of the roof module according to the invention can have various designs and comprise in particular a lidar sensor, a radar sensor, an optical sensor, such as a camera and/or the like. Lidar sensors operate in a wavelength range of 905 nm or even approximately 1.550 nm, for example. For the wavelength range used by the environment sensor, the material of the roof skin in the see-through portion should be transparent and the material should thus be chosen in accordance with the wavelength(s) used by the environment sensor.

In a particularly preferred embodiment, the at least one module component comprises at least one environment sensor which can send and/or receive electromagnetic signals through a see-through portion for detecting a vehicle environment around its optical axis and which is displaceable from the retracted position to the extended position in which it protrudes over the roof skin to detect the vehicle environment. Furthermore, according to this embodiment, the at least one cleaning nozzle is configured to clean the see-through portion. A field of view of the environment sensor preferably extends symmetrically around the optical axis of the environment sensor in the shape of a cone having a sensor-specific cone opening angle. Alternatively or additionally, the at least one module component can also be a cover flap, a housing, a spoiler or the like. Particularly preferably, the at least one module component can thus be any kind of component that is comprised in the roof module and is displaceable between several positons by means of a drive kinematic unit. According to the invention, the displaceability of this retracting and extending module component is synergistically used to also configure the cleaning nozzles so as to be retractable and extendable because the drive kinematic unit can be coupled with the cleaning nozzle.

In a preferred embodiment, the at least one drive kinematic unit is configured to cause a first movement sequence, in which the at least one module component is displaceable at least between the retracted position and the extended position, and to cause at least one second movement sequence, in which the at least one cleaning nozzle is displaceable from the retracted position to the extended position. Thus, the movement of the at least one module component and the at least one cleaning nozzle is preferably effected in the form of two separate movement sequences, and therefore, the cleaning nozzle(s) can preferably be displaced irrespective of the module component(s). Thus, the cleaning nozzle can be extended even if the module component has already been extended. It is also possible to retract the cleaning nozzle if the module component is (still) extended. It is also possible to displace both the module component and the cleaning nozzle to a plurality of intermediate positions, e.g. a maintenance position or the like, such that more than the retracted position and the extended position of the module component or the cleaning nozzle can be reached by means of the drive kinematic unit.

In a preferred embodiment, the drive kinematic unit is configured to displace the at least one module component along a first axis of movement and/or around a first rotation axis in the first movement sequence, and to displace the at least one cleaning nozzle along a second axis of movement and/or around a second rotation axis in the second movement sequence. The first axis of movement or the first rotation axis of the module component preferably differs from the second axis of movement or the second rotation axis of the cleaning nozzle in its position and direction. Thus, the module component can be rotated around the first rotation axis, and thus moved, by means of the drive kinematic unit in the course of the first movement sequence, for example, whereas the cleaning nozzle is moved along the second axis of movement (i.e., by an essentially (±10%) translational movement) during the second movement sequence, the first rotation axis and the second axis of movement being disposed at an angle of ≠0° to each other, i.e., not being positioned parallel to each other. It is also possible that the two axes of movement are positioned parallel but at a distance to each other and both the module component and the cleaning nozzle are moveable along their respective axis of movement in an essentially translational manner. A combined translational and rotatory movement of the module component and the cleaning nozzle is also conceivable. The first and/or second axis of movement and/or the first and/or second rotation axis can each be positioned parallel or at any angle to each other. Particularly preferably, however, the first axis of movement and/or the first rotation axis is always disposed at a distance from the second axis of movement and/or second rotation axis.

In a preferred embodiment, the drive kinematic unit comprises a drive which is moveable along a drive axis and/or around the drive axis. In general, the drive can also comprise several components, some of which rotate around a drive axis and others thus move along the drive axis (i.e., translationally). In a preferred embodiment, the drive comprises an electric motor or a Bowden cable. Other types of drives that are not explicitly mentioned here are also conceivable. For example, an (electrically driven) linear drive can also be used. The Bowden cable is preferably a moveable machine element for transmitting a mechanical movement and compression and tensile forces by means of a flexible combination of a wire rope and a shell which is compression-proof in the direction of travel.

In a preferred embodiment, the drive axis is positioned in a direction different from the first axis of movement and/or the second axis of movement and/or the first rotation axis and/or the second rotation axis. In other words, the drive axis is positioned in a different direction (i.e., not parallel and/or congruent) than at least one of the first axis of movement, the second axis of movement, the first rotation axis and the second rotation axis. Thus, the drive axis can preferably be positioned so as to not be parallel to the first rotation axis and/or first axis of movement of the module component and also the second rotation axis and/or second axis of movement of the cleaning nozzle, but instead comprise any angle. In a preferred embodiment, the drive axis is disposed at a respective distance from the first axis of movement and/or the second axis of movement and/or the first rotation axis and/or the second rotation axis.

In a preferred embodiment, the drive kinematic unit comprises a slide which is moveable along the drive axis by means of the drive and which comprises a slotted track in which a guiding pin is moveable, the guiding pin being configured to displace the at least one module component from the retracted position to the extended position by moving along the slotted track. The slide is preferably guided on a linear track (for example similar to a rail). The slotted track is preferably a predefined slit in the slide by means of whose form and length a desired movement sequence can be achieved. Particularly preferably, the slotted track comprises two track end portions which are essentially parallel to each other and a ramp-shaped track portion (which extends in the shape of a ramp). In general, other shapes of the slotted track are also possible. It is also preferred if the two parallel track end portions (of which one is preferably disposed at a lower end, the other on an upper end of the ramp-shaped track end portion) each form a stop for the guiding pin. An advantage of a slotted control system is that it allows a displacement optimized in terms of speed of the module component, but, at the same time, less assembly space is required for the displacement mechanism. By means of the first stop (at a lower end of the slotted track), the module component is fixed in the retracted position (when the guiding pin is in the stop position). By means of the second stop (at an upper end of the slotted track), the module component is fixed in the extended position (when the guiding pin is in the stop position). The guiding pin is preferably protected from falling out of the slotted track (for example by means of a protruding bead (similar to a rivet) or by means of a splint pin).

In a preferred embodiment, the drive comprises a motor having a drive pinion on which, for example, a flexible shaft is disposed which is connected to the slide. The motor is preferably an electric motor. By providing the flexible shaft, by means of which a (rotational) movement of the motor via the drive pinion is transmitted to a linear movement of the slide, a high level of design freedom can be ensured because the drive can be placed nearly freely on the side next to the other components of the drive kinematic unit. Particularly preferably, the drive is configured to displace the slide back and forth along an essentially linear track by means of the flexible shaft. The wording “essentially linear track” means that the slide is preferably moveable only along one movement axis (i.e., the drive axis), but is limited in its movement (apart from constructively necessary clearance) regarding other movement axes.

In a preferred embodiment, the guiding pin is fixed to the at least one module component. In this embodiment, the guiding pin is attached to the module component in such a manner that it is immobile relative thereto. Furthermore, the guiding pin is preferably guided so as to be movable in the slotted track, such that a movement of the slide along the guide track, as described above, is transmissible to the guiding pin. This movement can be transmitted to the guiding pin since the guiding pin is fixed relative to said module component, such that it can move back and forth between the retracted position and the extended position, depending on the direction of movement of the guiding pin in the slotted track.

In a preferred embodiment, the drive kinematic unit comprises at least one transmission element which is directly or indirectly connected to at least a part of the at least one cleaning nozzle so as to transmit forces. Preferably, a movement of the slide along the drive axis is transmissible by means of the transmission element to the at least one cleaning nozzle in such a manner that it is displaceable between the retracted position and the extended position. Preferably, the transmission element can also be connected directly or indirection to at least one part of the slide so as to transmit forces. The transmission element can thus be considered a type of connecting link between the slide and the at least one cleaning nozzle. For example, the transmission element can be in contact with a housing of the cleaning nozzle, such that a movement of the slide along the drive axis is transmitted to a displacement movement of the cleaning nozzle. The transmission element can be in direct contact (without intermediate components) with the part of the at least one cleaning nozzle. Alternatively, the transmission element can also be in indirect contact with the part of the cleaning nozzle, such that further intermediate components (lever, rods, hinges, etc.) can be interposed.

In a preferred embodiment, the transmission element comprises at least one preferably rocker-like lever element which can be mounted on a frame structure of the roof module or a nozzle housing of the cleaning nozzle by means of a fixed bearing, for example, and/or which is in connection with the drive kinematic unit and/or the at least one cleaning nozzle by means of a floating bearing, for example, so as to transmit forces. By means of the lever element, a movement of the drive kinematic unit is directly or indirectly transmissible to the at least one cleaning nozzle. By means of the lever element, which can be L-shaped, for example, a movement of the slide along the drive axis transmitted preferably to the at least one cleaning nozzle. For example, the slide can move an end portion of the lever element, this movement being converted to a displacement movement of the at least one cleaning nozzle via the lever. The term “directly” means that a respective component is in contact with another respective component without further intermediate components/parts so as to transmit forces. The term “indirectly” means that a respective component can be in contact with another respective component via one or several intermediate components/parts so as to transmit forces, such that several bearings, gear stages or the like can be interposed, for example. Starting from the drive, the force required for retracting and/or extending the at least one cleaning nozzle can thus be transmitted to the cleaning nozzle via one or several lever elements by means of the slide, for example. In this case, such a lever element can simply serve as a loose connecting link between the slide and the cleaning nozzle, for example, force only being transmitted to the cleaning nozzle via said connecting link if the slide makes contact with it. Alternatively, the at least one lever element can be in actual kinematic contact with the slide and thus be actively involved in the second movement sequence (for example through changes in direction), for example. The lever element can also be disposed in the manner of a suspension on a guide housing, in which at least one cleaning nozzle is displaceably guided, in order to transmit a movement of the slide to the cleaning nozzle from this position.

In a preferred embodiment, the drive kinematic unit comprises a buffer element which is disposed on a force-transmitting area of the slide which interacts with the transmission element at least once the second movement sequence has been initiated. The buffer element is preferably configured to ensure as steady a transmission as possible between the first movement sequence and the second movement sequence. Preferably, the buffer element can be disposed on the slide as a type of extension or attachment or be integrally connected to it. Preferably, the buffer component elongates the slide viewed along the drive axis. The buffer element can be made of a plastic, metal or the like and preferably have a type of rubber coating as buffering on an abutting surface by means of which the buffer element interacts with the transmission element. Preferably, the second movement sequence for extending the cleaning nozzle is initiated after the first movement sequence has been completed, i.e., the module component has been extended. Preferably, the slide is moved further along the guide track. The buffer element, which is disposed on the slide, preferably makes contact with the transmission element starting from a predetermined position and, for example, “thrusts” against it or interacts with it in another way. Starting from this thrusting movement, the second movement sequence is initiated, in which the cleaning sensor is being extended. To cushion this thrusting movement, the buffer element can damp the initial thrusting impulse such that a continuous, i.e., not sudden, transition between the first movement sequence and the second movement sequence is ensured.

Preferably, a restoring movement of the at least one cleaning nozzle is effected by means of the dead load of the at least one cleaning nozzle (from the extended position to the retracted position) or by means of another type of restoring. Preferably, a restoring from the extended position to the retracted position or vice versa can be effected by means of a restoring spring, for example. Such a restoring preferably also moves the transmission element back to a starting position (in which the transmission element initiates the second movement sequence. Such a restoring spring can be disposed on a bearing of the transmission element, for example, the transmission element in this case advantageously being connected, at least on one side, to a part of the at least one cleaning nozzle. Compared to the state of the art, the dimensioning of this restoring spring is noncritical, because the restoring force of the spring can be overcome significantly easier by means of the drive kinematic unit than it was by means of a hydraulic drive.

In a preferred embodiment, the at least one cleaning nozzle comprises at least one lid piece. The at least one lid piece lines up flush with the external surface of the roof skin of the vehicle roof in the retracted position of the at least one cleaning nozzle. In the extended position of the at least one cleaning nozzle, the at least one lid piece protrudes at least partly beyond the external surface of the roof skin of the vehicle roof, such that a cleaning fluid from the cleaning nozzle can emerge from the cleaning nozzle and be sprayed on the see-though-portion from the outside. In general, cleaning the see-through portion is also possible in the retracted position of the at least one cleaning nozzle, according to the invention.

Preferably, the at least one cleaning nozzle is positioned in the extended position such that the cone-shaped fluid jet strikes the see-through portion at a slanted angle. This embodiment is particularly preferred if two cleaning nozzles are used which are disposed on either side of the module component (for example, on either side of the environment sensor in the viewing direction of the optical axis, meaning on the right-hand and left-hand side of the environment sensor), for example. In this case, for example, each cleaning nozzle or at least a nozzle head of the cleaning nozzles can have a slanted angle relative to the optical axis of the environment sensor, such that the two cone-shaped fluid jets formed by means of the cleaning nozzle overlap at least in sections. Thus, the cleaning effect is increased at least in the overlapping area, which, depending on the cone opening angle, preferably covers nearly the entire see-through portion.

In general, any type of environment sensor can be installed in the roof module. Particularly advantageous are lidar sensors and/or radar sensors and/or camera sensors and/or multi-camera sensors.

It is clear that the embodiments and the illustrative examples described above and yet to be explained below can be formed not only individually but also in any combination without departing from the scope of the present invention. Additionally, any and all embodiments of the roof module refer to a motor vehicle comprising such a roof module.

An embodiment of the invention is schematically illustrated in the drawing and is described in an exemplary manner hereinafter.

### BRIEF DESCRIPTIONS OF THE DRAWINGS

FIG. 1 is a perspective view of a vehicle roof having a roof module according to the invention;

FIG. 2 is a side view of an embodiment of the roof module according to the invention with a module component in a retracted position and a cleaning nozzle in a retracted position;

FIG. 3 is a side view of an embodiment of the roof module according to the invention with the module component in an extended position and the cleaning nozzle in a retracted position; and

FIG. 4 is a side view of an embodiment of the roof module according to the invention with the module component in an extended position and the cleaning nozzle in an extended position.

### DETAILED DESCRIPTION

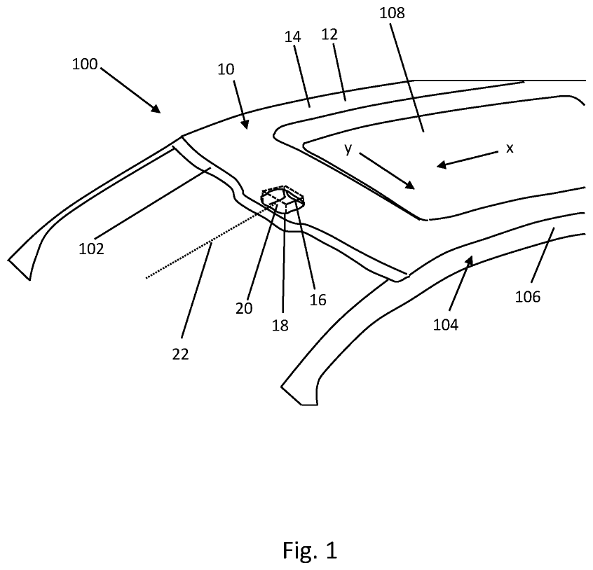

FIG. 1 shows a vehicle roof 100 of a vehicle (not fully shown) which comprises a roof module 10 according to the invention. Roof module 10 is inserted as a modular unit in a roof frame 104 of the vehicle or fitted on at least two transverse rails 102 and at least two longitudinal rails 106 which form roof frame 104. In the embodiment shown, roof module 10 has a panoramic roof 108.

Roof module 10 comprises a panel component 12 for forming a roof skin 14 of vehicle roof 100. In a front face area of vehicle roof 100 or of roof module 10 (viewed in a longitudinal direction x of the vehicle), a module component 16 is disposed symmetrically to the longitudinal axis x of the vehicle. In the present case, module component 16 is an environment sensor 18. In general, module component 16 can also be a cover, a spoiler, a housing component or the like.

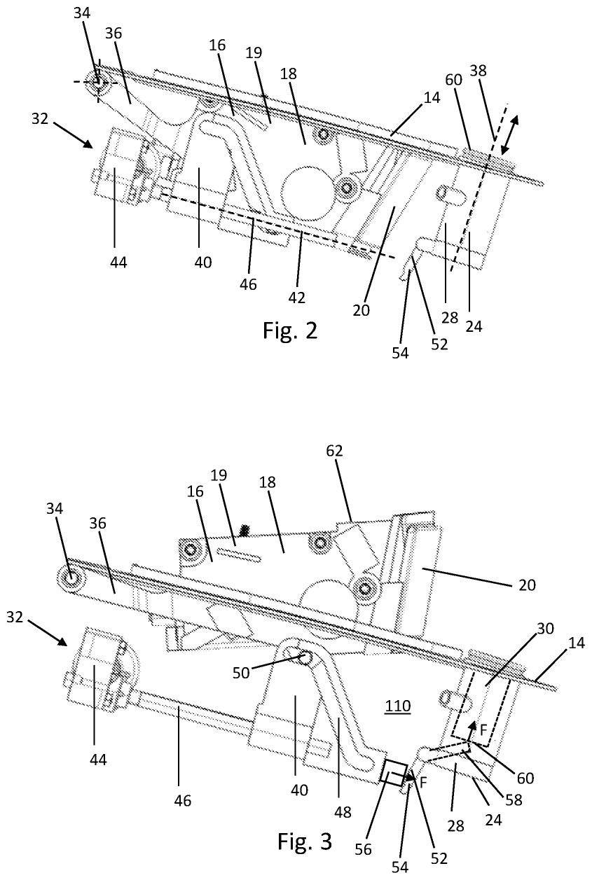

Environment sensor 18 is disposed directly behind a front transverse rail 102 which defines a roof header of the vehicle. Environment sensor 18 is displaceable between a retracted position (see FIG. 2) and an extended position (see FIGS. 2 and 3) or disposed (or mounted) so as to be retractable and extendable in an opening (not shown) in roof skin 14 of roof module 10 on a frame structure 110. Environment sensor 18 is disposed in an internal space of sensor housing 19 (see FIGS. 2 to 4). Sensor housing 19 forms a dry area in which environment sensor 18 is disposed so as to be moisture-proof. In the present case, environment sensor 18 is a lidar sensor. However, other types of sensors, such as (multidirectional) cameras, which are used for (semi-) autonomous driving, can also be used.

Environment sensor 18 or sensor housing 19 of environment sensor 18 comprises a see-through portion 20 which can be made of a preferably shatterproof plastic or another (semi-)transparent material, for example. Environment sensor 18 is positioned along an optical axis 22 which is positioned parallel to the longitudinal direction x of the vehicle in FIG. 1.

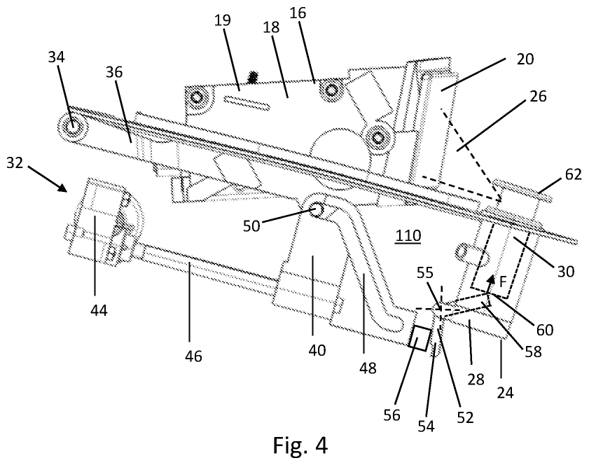

Furthermore, roof module 10 comprises at least one retractable and extendable cleaning nozzle 24 by means of which see-through portion 20 can be cleaned by means of a cleaning fluid (for example, a fluid or a gas). The cleaning fluid can be an aqueous soap solution, for example. Alternatively, compressed air or another pressurized gas can also be used for cleaning. Cleaning fluid emerging from cleaning nozzles 24 generates a cone-shaped fluid jet 26 which hits and cleans see-through portion 20 (see FIG. 4). If preferably two cleaning nozzles 24 are used, cone-shaped fluid jets 26 can preferably overlap at least in sections in an overlapping area of see-through portion 20 (not shown) to increase the cleaning effect in this overlapping area.

In the present case, cleaning nozzles 24 are disposed in a nozzle housing 28. Nozzle housing 28 is installed or mounted on frame structure 110. Nozzle housing 28 is designed such that at least one nozzle head 30 of cleaning nozzle 24 (which is configured to generate cone-shaped fluid jet 26) is mounted so as to be displaceable between a retracted position (see FIGS. 2 and 3) and an extended position (FIG. 4) in nozzle housing 28.

According the invention, both the displaceability of module component 16 (and/or environment sensor 18) at least between the retracted position and the extended position in the course of a first movement sequence and the displaceability of cleaning nozzle 24 (and/or at least the nozzle head) at least between the retracted position and the extended position in the course of a second movement sequence are provided by means of one single drive kinematic unit 32.

Drive kinematic unit 32 is configured to initiate the first movement sequence in which at least one module component 16 is displaced around a first rotation axis 34 between the retracted position and the extended position in the embodiment shown. In general, it is also possible that module component 16 is moved along a first axis of movement (not shown) or displaced between the retracted position and the extended position in a combined rotational movement and movement. For the rotation around first rotation axis 34 by means of a guiding lever 36, which is disposed on or integrally connected to housing 19, module component 16 is rotatably mounted on frame structure 110 of roof module 10.

Furthermore, drive kinematic unit 32 is configured to initiate the second movement sequence in which at least one cleaning nozzle 24 is displaced around a second axis of movement 38 between the retracted position and the extended position in the embodiment shown. In general, it is also possible that at least one cleaning nozzle 24 is rotated along a second rotation axis (not shown) or displaced between the retracted position and the extended position in a combined rotational movement and movement.

To this end, drive kinematic unit 32 has a slide 40 which is moveable along drive axis 42 by means of a drive 44 (in the present case, an electric motor). Slide 40 is guided on a guide track 46 along which slide 40 can glide. As can be seen in FIG. 2, drive axis 42 is positioned in a direction different from first rotation axis 34 and second axis of movement 38 each. In this case, drive axis 4 is positioned orthogonally to first rotation axis 34 and positioned essentially orthogonally (90°±10%) to second axis of movement 38. First rotation axis 34 is positioned orthogonally to second axis of movement 38. Slide 40 comprises a slotted track 48 in which a guiding pin 50 is moveable. By means of a movement of guiding pin 50 along slotted track 48, at least one module component 16 is displaceable from the retracted position to the extended position because guiding pin 50 is fixed to housing 19 such that its movement is transmitted to the housing and causes said housing 19 to rotate around first rotation axis 34. In this manner, drive kinematic unit 32 initiates the first movement sequence. In the present case, slotted track 48 is essentially ramp-shaped.

After module component 16 has reached the extended position (see FIGS. 3 and 4), the second movement sequence is initiated by the drive kinematic unit, such that cleaning nozzle 24 can also be displaced from the retracted position (see FIGS. 2 and 3) to the extended position (see FIG. 4). To this end, drive kinematic unit has a transmission element 52 in the present case. In the present case, transmission element 52 is formed in the manner of a tilting lever 54 (of a lever element) and mounted so as to be rotatable on nozzle housing 28. Tilting lever 54 is in direct connection with at least part of at least one cleaning nozzle 24, in the present case with nozzle head 30 so as to transmit forces. By means of a movement or rotation of tilting lever 54 around its bearing point 55 (in the form of a fixed bearing) on nozzle housing 28, a movement of slide 40 along drive axis 42 can be transmitted to at least one cleaning nozzle 24 such that it is displaceable between the retracted position and the extended position. Restoring cleaning nozzle 24 is preferably carried out via a restoring spring (not shown) or a counterweight.

Furthermore, drive kinematic unit 32 comprises a buffer element 56 which is disposed on a force-transmitting area of slide 40 which can interact with transmission element 52 or tilting lever 54 in this manner. Buffer element 56 is schematically marked as a block in FIG. 4. For example, buffer element 56 can be an additional component, which, viewed in the drive direction of slide 40, can be mounted as a type of extension on slide 40 or be integrally connected to it. After the first movement sequence has been completed, meaning environment sensor 18 has been extended, slide 40 can be moved even further along guide track 46, for example, to thus initiate the second movement sequence. In this case, slide 40 presses against tilting lever 54, which is formed rocker-like, for example, with buffer element 56, for example, with a force F. As is schematically illustrated in FIGS. 3 and 4 by means of dashed lines, tilting lever 54 rotates around bearing point 55 counter-clockwise in the present case because of this introduced momentum, force F being redirected via bearing point 55. Because of a preferably L-shaped design (which is usually covered by nozzle housing 28 and indicated only by dashes in FIG. 4) of tilting lever 54, an end 58 of tilting lever 54, which is disposed within nozzle housing 28, presses against a lower portion 60 of nozzle head 30 (see FIGS. 3 and 4), such that nozzle head 30 is being pressed into the extended position by means of a resulting force F (see FIG. 4). In the extended position of nozzle head 30, a lid piece 60 of cleaning nozzle 24 protrudes over roof skin 14. In the retracted state of cleaning nozzle 24, lid piece 60 preferably essentially lines up flush with roof skin 14. In the retracted state of environment sensors 18, a cover 62 of sensor housing 19 preferably also essentially lines up flush with roof skin 14.

1. A roof module for forming a vehicle roof on a motor vehicle, the roof module having:
a panel component whose external surface at least partially forms a roof skin of the vehicle roof,
the roof skin functioning as an outer sealing surface of the roof module, the roof module having at least one module component,
the roof module having a drive kinematic unit which is configured to displace the at least one module component from a retracted position to an extended position in which the at least one module component protrudes over the roof skin, and
the roof module having at least one cleaning nozzle,
wherein the drive kinematic unit is configured to also displace the at least one cleaning nozzle between a retracted position and an extended position.

2. The roof module according to claim 1, wherein the at least one module component comprises at least one environment sensor which sends and/or receives electromagnetic signals through a see-through portion for detecting a vehicle environment around its optical axis and which is displaceable from the retracted position to the extended position in which it protrudes over the roof skin to detect the vehicle environment, and the at least one cleaning nozzle is configured to clean the see-through portion.

3. The roof module according to claim 1, wherein at least one module component comprises at least one of a cover flap, a housing and a spoiler.

4. The roof module according to claim 1, wherein the at least one drive kinematic unit is configured to cause a first movement sequence, in which the at least one module component is displaceable at least between the retracted position and the extended position, and to cause at least one second movement sequence, in which the at least one cleaning nozzle is displaceable from the retracted position to the extended position.

5. The roof module according to claim 4, wherein, in the first movement sequence, the drive kinematic unit is configured to displace the at least one module component along a first axis of movement and/or around a first rotation axis and, in the second movement sequence, the drive kinematic unit is configured to displace the at least one cleaning nozzle along a second axis of movement and/or around a second rotation axis.

6. The roof module according to claim 1, wherein the drive kinematic unit comprises a drive which is moveable along a drive axis and/or around the drive axis.

7. The roof module according to claim 5, wherein the drive axis is positioned in a direction different from the first axis of movement and/or the second axis of movement and/or the first rotation axis and/or the second rotation axis.

8. The roof module according to claim 6, wherein the drive kinematic unit comprises a slide which is moveable along the drive axis by the drive and which comprises a slotted track in which a guiding pin is moveable, the guiding pin being configured to displace the at least one module component from the retracted position to the extended position by moving along the slotted track.

9. The roof module according to claim 6, wherein the guiding pin is moveable between a first stop of the slotted track by means of which the at least one module component is fixed in the retracted position and a second stop of the slotted track by means of which the at least one module component is fixed in the extended position.

10. The roof module according to claim 8, wherein the slotted track is essentially ramp-shaped.

11. The roof module according to claim 8, wherein the guiding pin is fixed to the at least one module component.

12. The roof module according to claim 8, wherein the drive kinematic unit comprises at least one transmission element which is directly or indirectly connected to at least a part of the at least one cleaning nozzle so as to transmit forces and by means of which a movement of the slide along the drive axis is transmissible to the at least one cleaning nozzle in such a manner that the latter is displaceable between the retracted position and the extended position.

13. The roof module according to claim 12, wherein the transmission element comprises at least one preferably rocker-like lever element which is mounted a fixed bearing and/or which is connected to the drive kinematic unit and/or the at least one cleaning nozzle by a floating bearing so as to transmit forces and by means of which a movement of the drive kinematic unit is directly or indirectly transmissible to the at least one cleaning nozzle.

14. The roof module according to claim 12, wherein the drive kinematic unit comprises a buffer element which is disposed on a force-transmitting area of the slide which interacts with the transmission element.

15. The roof module according to claim 1, wherein the at least one cleaning nozzle comprises at least one lid piece and the at least one lid piece lines up flush with the external surface of the roof skin of the vehicle roof in the retracted position of the at least one cleaning nozzle and protrudes at least partly beyond the external surface of the roof skin of the vehicle roof in the extended position of the at least one cleaning nozzle.

16. The roof module according to claim 2, wherein the at least one environment sensor is formed in the manner of a lidar sensor and/or in the manner of a radar sensor and/or in the manner of a camera sensor and/or in the manner of a multi-camera sensor.

17. The roof module according to claim 1, wherein the at least one cleaning nozzle is disposed so as to be distanced from the at least one module component.

18. A motor vehicle comprising a roof module according to claim 1.
